(19) United States
(12) Patent Application Publication
(10) Pub. No.: US 2024/0330941 A1
(43) Pub. Date: Oct. 3, 2024

(54) SELECTIVE ACTIVITY LOGGING IN A CUSTOMER RELATIONSHIP MANAGEMENT (CRM) SYSTEM

(71) Applicant: ZoomInfo Technologies LLC, Vancouver, WA (US)

(72) Inventors: Jen HSIN, San Francisco, CA (US); Bertrand LUI, Los Altos, CA (US)

(21) Appl. No.: 18/740,307

(22) Filed: Jun. 11, 2024

Related U.S. Application Data
(63) Continuation of application No. 17/477,526, filed on Sep. 16, 2021, now abandoned.

(51) Int. Cl. G06Q 30/01; G06F 16/903; G06Q 10/107

(52) U.S. Cl. CPC G06Q 30/01; G06F 16/90335; G06Q 10/107

(57) ABSTRACT

The selective logging of external activities internally within a CRM application includes an extraction of a document such as an e-mail message from a communications client and a further extraction from the document of a set of associated parties. A CRM application is then queried with the set of associated parties and in response, an identity of a customer can be received from the CRM application along with a listing of one or more CRM end users assigned to the customer. On condition that one of the associated parties is determined to be one of the CRM end users, an activity is then recorded in the CRM application in connection with the one of the CRM end users based upon the document. But otherwise the document is discarded.

### CROSS-REFERENCE TO RELATED APPLICATIONS

This application is a Continuation of U.S. Non-Provisional application Ser. No. 17/477,526, entitled, SELECTIVE ACTIVITY LOGGING IN A CUSTOMER RELATIONSHIP MANAGEMENT (CRM) SYSTEM,” filed Sep. 16, 2021, which is incorporated herein by reference in their entirety for all purposes.

### BACKGROUND OF THE INVENTION

### Field of the Invention

The present invention relates to the field of CRM and more particularly to the logging of activities pertaining to a business opportunity in a CRM system.

### Description of the Related Art

CRM refers to the interaction that a business entity enjoys with its customers, whether the business entity provides sales or services to the customer. CRM is often thought of as a business strategy that enables business managers to understand the customer, to retain customers through better customer experience, to attract new customers, increase profitability and to decrease customer management costs. In real terms, however, CRM systems are used specifically to manage business contacts, clients, contract wins and sales leads. As such, CRM solutions provide the end user with the customer business data necessary to provide services or products desired by the customers, to provide better customer service, to cross-sell and to up-sell more effectively, to close deals, retain current customers and understand the identity of the customer.

Central to a CRM solution is the notion of a “business opportunity”. A business opportunity in the context of CRM is synonymous with a “sales opportunity” as an element of the “sales pipeline”. A sales pipeline describes an approach to selling, founded on the underlying principles of the sales process. More particularly, the sales pipeline describes the individual steps salespeople undertake from initial contact with a potential customer, or “prospect”, to qualifying that prospect into a lead, and further validating that lead into a sales opportunity followed through the different stages until closed. A lead pipeline, in turn, is the more granular process of validating a prospect from initial contact through prospect to lead. With respect to the former, all sales opportunities arranged along each of the sales steps that make up the sales process represented by the sales pipeline. Thus, a business opportunity is a qualified and validated lead for a potential sale of a product or service.

The fundamental interface between sales professional and business opportunity is the activity. An activity describes an even that occurs as between the sales professional or sales organization to which the professional belongs, and a representative of the prospective customer providing the business opportunity. In the modern era, the most typical forms of the activity are the electronic message or telephone call. As it is well understood, there is a strong correlation between the nature and number of activities like messages and calls, and the probability that a business opportunity will close within a particular time frame. Thus, from a management perspective, detecting the occurrence of different activities during the course of conducting a sales campaign can be important to monitoring the progress of the sales campaign.

Yet, the tools used to track the occurrence of activities, namely communications applications, are not included as part of the CRM system and are often integrated with the CRM system in only a loose and non-confederated way. Accordingly, there is no opportunity to process the existence of an activity as the activity occurs, filter the activity to the correct actors in the CRM system and associate the activity with the correct business opportunity and sales professional. Instead, if any organizational effort is to occur in respect to the activities of the communications application, the effort must be manual which is not possible in a large sales organization using a CRM system of hundreds if not thousands of business opportunities and hundreds if not thousands of sales professionals individually associated with ones of the different opportunities at varying levels of responsibility. As a result, the ability to effectively manage the use of the CRM system is lost.

### BRIEF SUMMARY OF THE INVENTION

Embodiments of the present invention address technical deficiencies of the art in respect to CRM activity tracking. To that end, embodiments of the present invention provide for a novel and non-obvious method for selectively logging external activities internally within a CRM application. Embodiments of the present invention also provide for a novel and non-obvious computing device adapted to perform the foregoing method. Finally, embodiments of the present invention provide for a novel and non-obvious data processing system incorporating the foregoing device in order to perform the foregoing method.

In one embodiment of the invention, a method for selectively logging external activities internally within a CRM application includes the extraction of a document such as an e-mail message from a communications client and the further extraction from the document of a set of associated parties. The method also includes querying a CRM application with the set of associated parties and the resulting receipt from the CRM application of an identity of a customer and a listing of one or more CRM end users assigned to the customer. As such, on condition that one of the associated parties is determined to be one of the CRM end users, an activity can be recorded in the CRM application in connection with the one of the CRM end users based upon the document. But otherwise the document can be discarded.

In one aspect of the embodiment, the listing of one or more CRM end users assigned to the customer can be derived from a territory assigned to the customer and a corresponding selection of the CRM end users assigned to the territory. However, in another aspect of the embodiment, the listing of one or more CRM end users assigned to the customer can be derived from a product class assigned to the customer and a corresponding selection of the CRM end users assigned to the product class. In yet another alternative, the listing of one or more CRM end users assigned to the customer can be derived from a context assigned to the customer and a corresponding selection of the CRM end users assigned to the context and the activity can be recorded in connection the one of the CRM end users selected amongst two or more of the CRM end users both included in the set of associated parties based upon a prioritization rule for the context.

In another embodiment of the invention, a data processing system is adapted for selectively logging external activities internally within a CRM application. The system includes a host computing platform of one or more computers, each with memory and one or processing units including one or more processing cores. The system also includes a logging module comprising computer program instructions enabled while executing in the memory of at least one of the processing units of the host computing platform to extract both a document from a communications client and, from the document, a set of associated parties. The program instructions additionally are enabled to query a CRM application with the set of associated parties and to receive from the CRM application in response to the querying, an identity of a customer and a listing of one or more CRM end users assigned to the customer. Finally, the program instructions are enabled to record an activity in the CRM application, on the condition that one of the associated parties is determined to be one of the CRM end users, in connection with the one of the CRM end users based upon the document, but otherwise the program instructions are enabled to discard the document.

In yet another embodiment of the invention, a computing device includes a non-transitory computer readable storage medium having program instructions stored therein. The instructions are executable by at least one processing core of a processing unit to cause the processing unit to perform the selective logging of external activities internally within a CRM application. In this regard, the instructions perform an extraction of a document from a communications client and an extraction from the document of a set of associated parties. The instructions further perform a querying of a CRM application with the set of associated parties and a receiving from the CRM application in response to the querying of an identity of a customer and a listing of one or more CRM end users assigned to the customer. Finally, the instructions perform, on condition that one of the associated parties is determined to be one of the CRM end users, a recording an activity in the CRM application in connection with the one of the CRM end users based upon the document. But, otherwise the instructions perform a discarding of the document.

In this way, the technical deficiencies of coordinating the occurrence of activities in a communications application disjoint from the CRM system are overcome owing to the processing of text of a communication for a customer resulting in the identification of all of the associated parties and the association of the identified parties, wherever possible, with an end user of the CRM system assigned to the customer.

Consequently, activities reflected by corresponding communications may be recorded in the CRM system in respect to associated business opportunities in the CRM system for respective customers of the CRM system wherever it is determined that the associated parties to a communication correlate to a CRM end user or CRM end users assigned to the customer referenced in the communication. But, whenever a communication fails to implicate associated parties identified to correspond to a CRM end user assigned to the customer, the communication is simply discarded resulting in the tracking of activities for CRM end users truly associated with those CRM end users for corresponding opportunities registered with the CRM system.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration reflecting different aspects of a process of selectively logging external activities internally within a CRM application;

FIG. 2 is a block diagram depicting a data processing system adapted to perform one of the aspects of the process of FIG. 1; and,

FIG. 3 is a flow chart illustrating one of the aspects of the process of FIG. 1.

### DETAILED DESCRIPTION OF THE INVENTION

Embodiments of the invention provide for selectively logging external activities internally within a CRM application. In accordance with an embodiment of the invention, communications within a communications application are monitored and, for each communication, a list of parties to the communication can be extracted. Thereafter, a CRM system is queried with the list of parties in order to determine whether or not one of the parties in the list is a customer recorded in the CRM system. If not, the communication is disregarded. But otherwise, a set of CRM end users associated with the customer are identified and compared to the list of parties. To the extent that none in the list of parties are identified as CRM end users associated with the customer, the communication is disregarded. Both otherwise, a record is written in connection with one or more of the CRM end users of the list of parties associating therewith the communication. In this way, only communications relevant to a particular CRM end user and associated customer are recorded with respect to the customer in the CRM system while irrelevant communications are discarded.

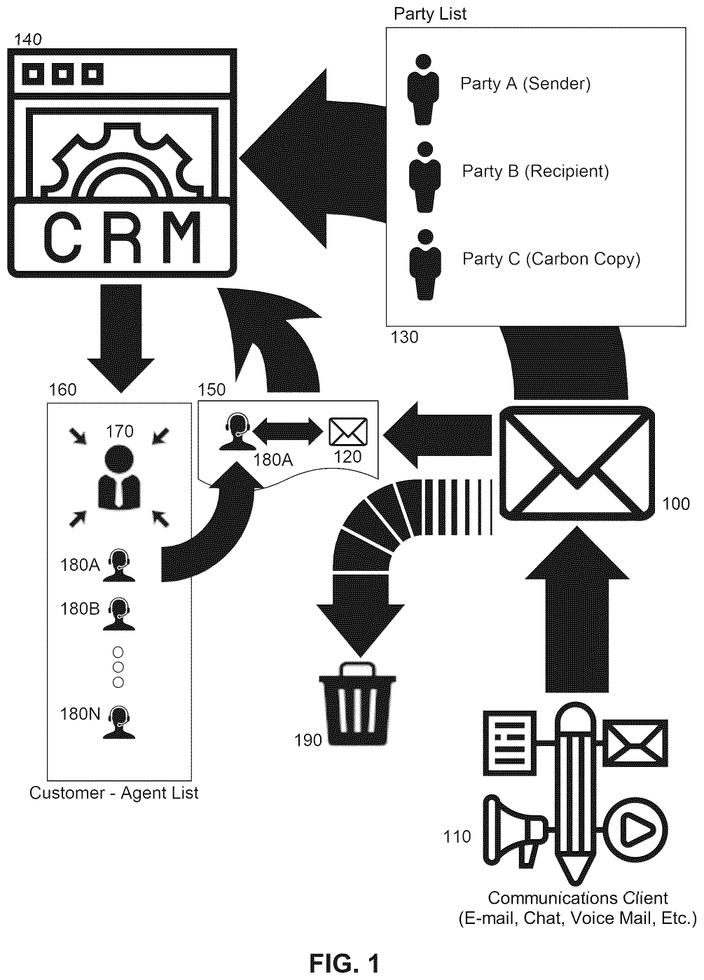

In illustration of one aspect of the embodiment, FIG. 1 pictorially shows a process for selectively logging external activities internally within a CRM application. As shown in FIG. 1, an external activity 100, such as the receipt of an e-mail message received in communications client 110, is processed so as to extract therefrom a party list 130 of different parties to the external activity 100, such as the sender of the e-mail message, one or more recipients of the e-mail message and one or more carbon copy recipients of the e-mail message. The party list 130 is then compared to a contact data store in a CRM system 140 in order to determine whether or not any of the parties to the external activity 100 have been registered as a customer 170 in the CRM system 140.

To the extent that one of the parties in the party list 130 is a customer 170 in the CRM system 140, a customer agent list 160 is produced associating the customer 170 with one or more different end users 180A, 180B, 180N of the CRM system 140. In this regard, the customer agent list 160 can be derived from a territory assigned to the customer 170 and a corresponding selection of the CRM end users 180A, 180B, 180N assigned to the territory. Alternatively, the customer agent list 160 can be derived from a product class assigned to the customer 170 and a corresponding selection of the CRM end users 180A, 180B, 180N assigned to the product class. As yet another alternative, the customer agent list 160 can be derived from a context assigned to the customer 170 and a corresponding selection of the CRM end users 180A, 180B, 180N.

It is then further determined whether or not one or more of the parties in the party list 130 can be identified as one of the different CRM end users 180A, 180B, 180N. In the event that one CRM end user 180A amongst the different CRM end users 180A, 180B, 180N is present in the party list 130, a record 150 is written to the CRM system 140 associating a reference 120 to the communication 100 with the one end user 180A amongst the different end users 180A, 180B, 180N. To the extent that the customer agent list 160 has been derived from a context assigned to the customer 170 and a corresponding selection of the CRM end users 180A, 180B, 180N, the external activity 100 is recorded in the record 150 in connection with one of the CRM end users 180A, 180B, 180N selected amongst two or more of the CRM end users 180A, 180B, 180N based upon a prioritization rule for the context.

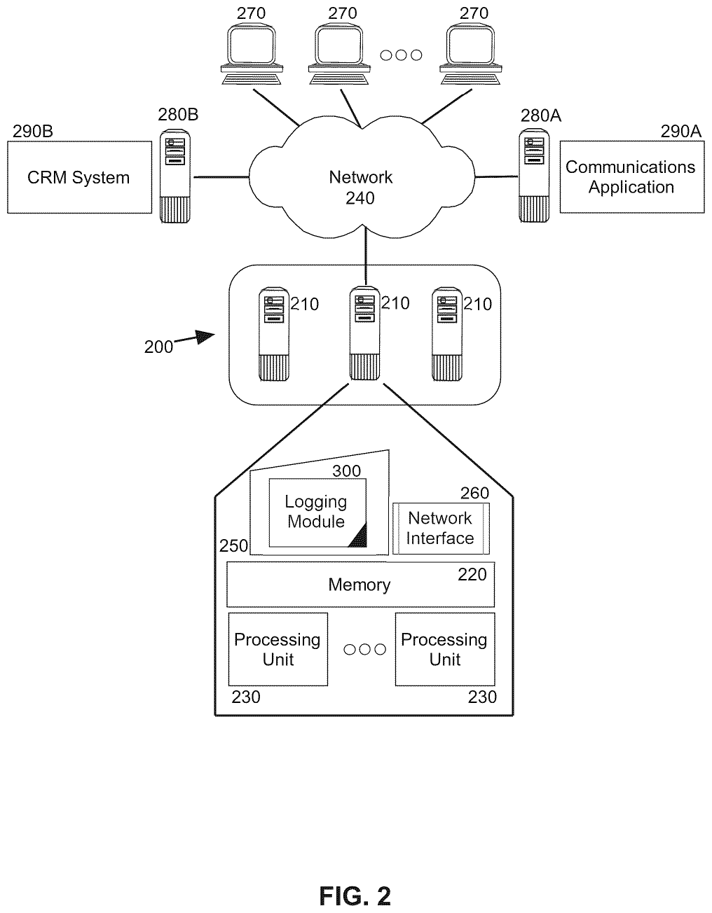

Aspects of the process described in connection with FIG. 1 can be implemented within a data processing system. In further illustration, FIG. 2 schematically shows a data processing system adapted to selectively log external activities internally within a CRM application. In the data processing system illustrated in FIG. 1, a host computing platform 200 is provided. The host computing platform 200 includes one or more computers 210, each with memory 220 and one or more processing units 230. The computers 210 of the host computing platform 200 (only a single computer shown for the purpose of illustrative simplicity) can be co-located within one another and in communication with one another over a local area network, or over a data communications bus, or the computers can be remotely disposed from one another and in communication with one another through network interface 260 over a data communications network 240.

The host computing platform 200 is communicatively coupled over the data communications network 240 to a server 280A hosting the operation of a communications application 290A adapted to process communications between different senders and recipients of the communications by way of computing clients 270. As well, the host computing platform 200 is communicatively coupled over the data communications network 240 to another server 280B hosting the operation of a CRM system 290B in which different records of different customers are stored in association with one or more different end users of the CRM system 290B.

Notably, a computing device 250 including a non-transitory computer readable storage medium can be included with the data processing system 200 and accessed by the processing units 230 of one or more of the computers 210. The computing device stores 250 thereon or retains therein a program module 300 that includes computer program instructions which when executed by one or more of the processing units 230, performs a programmatically executable process for selectively logging external activities internally within a CRM application. Specifically, the program instructions during execution process a communication in the communications application 290 in order to identify different parties to the communication. The program instructions then query the CRM system 290B in order to determine if one of the different parties is registered as a customer in the CRM system 290B. If not, the program instructions discard the communication.

In the event that the program instructions determine from the query that one of the different parties is registered as a customer in the CRM system 290B, the program instructions further determine if one of the different parties matches a CRM end user of the CRM system 290B associated with the customer. If not, again the program instructions discard the communication. But otherwise, the program instructions write a record to the CRM system 290B associating the communication with the matched CRM end user of the CRM system 290B.

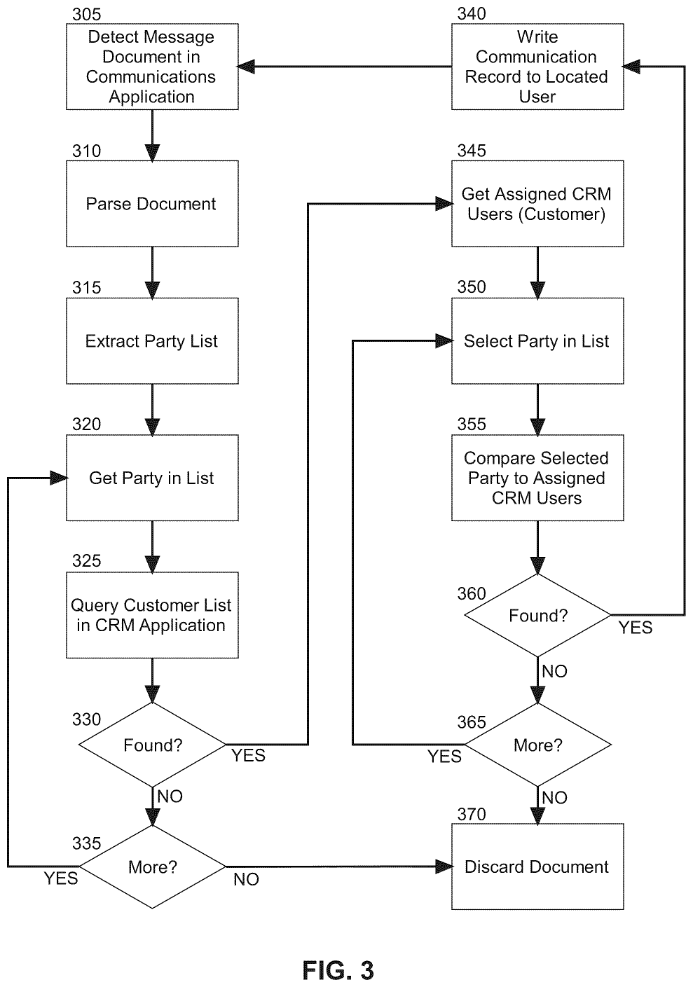

In further illustration of an exemplary operation of the module, FIG. 3 is a flow chart illustrating one of the aspects of the process of FIG. 1. Beginning in block 305, a message document is detected in a communications application, and in block 310, the document is parsed to identify the content of the document—namely the parties to the message document. Then, in block 315, a list of parties to the message document is extracted from the message document and in block 320, a first party in the list is retrieved. In block 325, a list of customers in the CRM system is inspected to determine if the party is a customer registered in the CRM system. In decision block 330, if it is determined that the party is not a customer registered in the CRM system, in decision block 335 it is determined if additional parties in the list remain to be processed against the customer list. If not, the message document is discarded in block 370. Otherwise, the process continues in block 320 with a next party in the list until a party in the list is determined in decision block 330 to match a customer registered in the CRM system.

In decision block 330, upon determining that a party in the list matches a customer registered in the CRM system, in block 345 one or more associated CRM users are retrieved for the customer. In block 350, a first party in the list is selected and in block 355, the selected party is compared to the CRM users in order to determine in decision block 360 if one of the parties to the message document is a CRM user associated with the customer. If not, in decision block 365 it is determined if additional parties in the list remain to be processed against the CRM users associated with the customer. If not, the message document is discarded in block 370. Otherwise, the process continues in block 350 with a next party in the list until a party in the list is determined in decision block 360 to match a CRM user associated with the message document. Thereafter, in block 340 a record is written in the CRM system in connection with the matched CRM user referencing the message communication.

Of import, the foregoing flowchart and block diagram referred to herein illustrate the architecture, functionality, and operation of possible implementations of systems, methods, and computing devices according to various embodiments of the present invention. In this regard, each block in the flowchart or block diagrams may represent a module, segment, or portion of instructions, which includes one or more executable instructions for implementing the specified logical function or functions. In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

More specifically, the present invention may be embodied as a programmatically executable process. As well, the present invention may be embodied within a computing device upon which programmatic instructions are stored and from which the programmatic instructions are enabled to be loaded into memory of a data processing system and executed therefrom in order to perform the foregoing programmatically executable process. Even further, the present invention may be embodied within a data processing system adapted to load the programmatic instructions from a computing device and to then execute the programmatic instructions in order to perform the foregoing programmatically executable process.

To that end, the computing device is a non-transitory computer readable storage medium or media retaining therein or storing thereon computer readable program instructions. These instructions, when executed from memory by one or more processing units of a data processing system, cause the processing units to perform different programmatic processes exemplary of different aspects of the programmatically executable process. In this regard, the processing units each include an instruction execution device such as a central processing unit or “CPU” of a computer. One or more computers may be included within the data processing system. Of note, while the CPU can be a single core CPU, it will be understood that multiple CPU cores can operate within the CPU and in either instance, the instructions are directly loaded from memory into one or more of the cores of one or more of the CPUs for execution.

Aside from the direct loading of the instructions from memory for execution by one or more cores of a CPU or multiple CPUs, the computer readable program instructions described herein alternatively can be retrieved from over a computer communications network into the memory of a computer of the data processing system for execution therein. As well, only a portion of the program instructions may be retrieved into the memory from over the computer communications network, while other portions may be loaded from persistent storage of the computer. Even further, only a portion of the program instructions may execute by one or more processing cores of one or more CPUs of one of the computers of the data processing system, while other portions may cooperatively execute within a different computer of the data processing system that is either co-located with the computer or positioned remotely from the computer over the computer communications network with results of the computing by both computers shared therebetween.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for selectively logging external activities internally within a customer relationship management (CRM) application, the method comprising:
establishing a communicative coupling to both a communications client executing in a computing platform, and also a CRM application remotely disposed from over a computer communications network;
extracting a document comprising an e-mail message from the communications client;
extracting from the e-mail message, a set of associated parties comprising each of a sender of the e-mail message and one or more specified recipients of the e-mail message;
transmitting a query to the communicatively coupled CRM application with the set of associated parties in order to determine if a customer record of the CRM application matches one of the associated parties of the e-mail message;
receiving in response to the transmitted query from the CRM application, an identity of a customer stored in a record of the CRM application and a corresponding territory; feeding back to the CRM application, an additional query with the territory in order to identify one or more CRM end users assigned to the customer; and,
recording an activity in the CRM application for the one of the CRM end users based upon the document.

2. A data processing system adapted for selectively logging external activities internally within a customer relationship management (CRM) application, the system comprising:
a host computing platform comprising one or more computers, each with memory and one or processing units including one or more processing cores; and,
a logging module comprising computer program instructions enabled while executing in the memory of at least one of the processing units of the host computing platform to perform:
establishing a communicative coupling to both a communications client executing in the host computing platform, and also a CRM application remotely disposed from over a computer communications network;
extracting a document comprising an e-mail message from the communications client;
extracting from the e-mail message, a set of associated parties comprising each of a sender of the e-mail message and one or more specified recipients of the e-mail message;
transmitting a query to the communicatively coupled CRM application with the set of associated parties in order to determine if a customer record of the CRM application matches one of the associated parties of the e-mail message;
receiving in response to the transmitted query from the CRM application, an identity of a customer stored in a record of the CRM application and a corresponding territory;
feeding back to the CRM application, an additional query with the territory in order to identify one or more CRM end users assigned to the customer; and,
recording an activity in the CRM application for the one of the CRM end users based upon the document.

3. A computing device comprising a non-transitory computer readable storage medium having program instructions stored therein, the instructions being executable by at least one processing core of a processing unit to cause the processing unit to perform a method for selectively logging external activities internally within a customer relationship management (CRM) application, the method including:
establishing a communicative coupling to both a communications client executing in a computing platform, and also a CRM application remotely disposed from over a computer communications network;
extracting a document comprising an e-mail message from the communications client; extracting from the e-mail message, a set of associated parties comprising each of a sender of the e-mail message and one or more specified recipients of the e-mail message;
transmitting a query to the communicatively coupled CRM application with the set of associated parties in order to determine if a customer record of the CRM application matches one of the associated parties of the e-mail message;
receiving in response to the transmitted query from the CRM application, an identity of a customer stored in a record of the CRM application and a corresponding territory;
feeding back to the CRM application, an additional query with the territory in order to identify one or more CRM end users assigned to the customer; and,
recording an activity in the CRM application for the one of the CRM end users based upon the document.
